(19) United States
(12) Patent Application Publication
(10) Pub. No.: US 2026/0359116 A1
(43) Pub. Date: Nov. 12, 2026

(54) DYNAMICALLY VARYING TIME SLICE PERIODS IN A COMPUTER PROCESSOR UNIT

(71) Applicant: QUALCOMM Incorporated, San Diego, CA (US)

(72) Inventors: Nan Zhang, Beijing (CN); Yongjun Xu, Beijing (CN)

(21) Appl. No.: 19/109,262

(22) PCT Filed: Dec. 22, 2022
(86) PCT No.: PCT/CN2022/140962

§ 371 Date: Mar. 6, 2025

(30) Foreign Application Priority Data
Sep. 9, 2022 (WO) PCT/CN2022/117994

(51) Int. Cl. G06F 9/48

(52) U.S. Cl. CPC G06F 9/4893; G06F 9/4825

(57) ABSTRACT

Exemplary aspects include dynamically varying a thread execution time slice in a processor in response to detected changes in FPS (frames per second) QoS (Quality of Service) requirements. A computer processor and/or operating system (OS) is configured to generate a scheduler interrupt in response to a timer signal. A scheduler service routine executes in response to the scheduler interrupt to schedule pending threads for execution. The frequency of the timer signal controls the frequency or time slice allocated to the current thread being executed before the thread is interrupted for the scheduler service routine. To avoid having a fixed timer signal be at a frequency to achieve a maximum FPS QOS requirement, which causes frequent and needless scheduling interrupts, the frequency of the timer signal is dynamically varied to control the duration of the thread time slice to still be sufficient to service the current FPS QoS.

### PRIORITY APPLICATION

The present application claims priority to International Patent Application Serial No. PCT/CN 2022/117994, filed Sep. 9, 2022 and entitled “DYNAMICALLY VARYING TIME SLICE PERIODS IN A COMPUTER PROCESSOR UNIT,” which is incorporated herein by reference in its entirety.

### BACKGROUND

### I. Field of the Disclosure

The technology of the disclosure relates generally to modifying processor time slices allocated to software threads and processes.

### II. Background

Computer processor unit (CPU) time slices allocated to software threads and processes are periods of time where such threads and processes run on a processor without being interrupted for the processor's scheduler. When processor time slices are relatively long, more time is allocated on the processor to run instructions associated with a respective thread or process before a periodic interrupt will force the processor's scheduler to check whether other threads/processes need to be dispatched for execution on the processor. The longer the time slice allocated to a thread/process, the longer the time other pending threads/processes have to wait before being dispatched. Additionally, the longer the time slice allocated to a thread/process, the thread/process will complete its processing in a shorter amount of elapsed time, also known as higher application throughput. When a processor time slice is relatively shorter, interrupts are generated more frequently, causing more interrupts without dispatching waiting threads which, in turn, consumes power. Additionally, the shorter the processor time slice, the shorter the amount of time pending threads/processes have to wait to get serviced by the processor and the longer amount of elapsed time it takes for threads/processes to complete, also known as lower application throughput.

### SUMMARY

Exemplary aspects include dynamically varying a thread execution time slice in a processor in response to detected changes in FPS (frames per second) QoS (Quality of Service) requirements. In exemplary aspects, the computer processor unit is included in a processor-based system that includes other peripheral devices, such as memory and input/output (I/O) devices, such as a display, as examples. The computer processor and/or operating system (OS) is configured to generate a scheduler interrupt in response to a timer signal that is generated by a timer circuit. The computer processor and/or its operating system is configured to execute a scheduler service routine in response to the scheduler interrupt to schedule pending threads for execution. Thus, the frequency of the timer signal controls the frequency or time slice allocated to the current thread being executed before the thread is interrupted for the scheduler service routine to determine whether to re-schedule pending threads. In computer processors employed in applications that control display functions, certain threads that are involved in display operations (e.g., rendering, composition, refresh) have an FPS QoS requirement so that those threads complete their work without dropping frames. In exemplary aspects, to avoid having a fixed timer signal be at a frequency to achieve the maximum FPS QoS requirement, which in turn causes a higher power consumption from more frequent scheduling interrupts, the processor or its operating system can dynamically change the frequency of the timer signal to control the duration of the thread time slice to lower the frequency of scheduling interrupts while still being sufficient to service the current FPS QoS. In this manner, the thread time slice is shortened or lengthened to a time frame that corresponds to service a current FPS QOS requirement.

In this regard, in one exemplary aspect, an apparatus is provided. The apparatus includes a computer processor unit (CPU), a display unit; a scheduler timer circuit; and an FPS control circuit configured to receive a signal indicating a new frame rate QoS requirement from a current frame rate QoS requirement in response to the signal indicating the new frame rate QoS requirement, the FPS control circuit is configured to determine a corresponding time slice period, and set the scheduler timer circuit to the corresponding time slice period, wherein the computer processor unit is configured, upon expiration of the scheduler timer circuit, to interrupt a thread from running on the computer processor unit in order to determine whether to schedule one or more pending threads.

The apparatus may further comprise a frame rate source circuit configured to generate the signal indicating the new frame rate quality of service requirement.

The frame rate source circuit may be a thermal sensor configured to generate the signal indicating the new frame rate quality of service requirement when the thermal sensor senses a temperature beyond a temperature threshold.

The frame rate source circuit may be a user interface circuit configured to generate the signal indicating the new frame rate quality of service requirement in response to input from a user.

The frame rate source circuit may be an application configured to generate the signal indicating the new frame rate quality of service requirement based on requirements of the application.

The apparatus may further comprise a pre-configured table of FPS rate QoS requirements and corresponding time slice periods, wherein the frames per second control circuit determines the corresponding time slice period by retrieving the corresponding time slice period associated with the new frame rate quality of service requirement from the pre-configured table of FPS rate QoS requirements.

The frames per second control circuit may determine the corresponding time slice period by dividing a period of the new frame rate quality of service requirement by x where x is less than 3 and greater than or equal to 2.

The frames per second control circuit may determine the corresponding time slice period by an AI engine.

In another exemplary aspect, a method for dynamically varying time slice periods in a computer processor unit is provided. The method comprises receiving a signal indicating a change from a current frame rate QoS requirement. The method also comprises determining a corresponding time slice period in response to the signal indicating a new frame rate QoS requirement. The method also comprises setting a scheduler timer circuit to the corresponding time slice period. The method also comprises interrupting a thread from running on a computer processor unit in order to determine whether to schedule one or more pending threads upon expiration of the scheduler timer circuit.

The method may further comprise generating the signal indicating the change from the current frame rate quality of service requirement.

Determining the corresponding time slice period may include retrieving the corresponding time slice period associated with the new frame rate quality of service requirement from a table.

Determining the corresponding time slice period may include dividing a period of the new frame rate quality of service requirement by x where x is less than 3 and greater than or equal to 2.

Determining the corresponding time slice period may include receiving the corresponding time slice period from an AI engine.

In another exemplary aspect, a non-transitory computer-readable storage medium comprising instructions executable by a processor, which, when executed by the processor, causes the processor to periodically interrupt a running thread in order to schedule one or more pending threads, the non-transitory computer-readable storage medium is provided. The non-transitory computer-readable storage medium comprises a code for receiving a signal indicating a change from a current frame rate QoS requirement. The non-transitory computer-readable storage medium also comprises a code for determining a corresponding time slice period in response to the signal indicating a new frame rate QoS requirement. The non-transitory computer-readable storage medium also comprises a code for setting a scheduler timer circuit to the corresponding time slice period. The non-transitory computer-readable storage medium also comprises a code for interrupting a thread from running on a computer processor unit in order to determine whether to schedule one or more pending threads upon expiration of the scheduler timer circuit.

The non-transitory computer-readable storage medium may further comprise code for generating the signal indicating the change from the current frame rate quality of service requirement.

The code for determining the corresponding time slice period may further include code for retrieving the corresponding time slice period associated with the new frame rate quality of service requirement from a table.

The code for determining the corresponding time slice period may further include code for dividing a period of the new frame rate quality of service requirement by x where x is less than 3 and greater than or equal to 2.

The code for determining the corresponding time slice period may further includes code for receiving the corresponding time slice period from an AI engine.

In another exemplary aspect, an apparatus is provided. The apparatus comprises means for receiving a signal indicating a change from a current frame rate QoS requirement. The apparatus also comprises means for determining a corresponding interrupt time slice period in response to the signal indicating a new frame rate QoS requirement. The apparatus also comprises means for setting a scheduler timer circuit to the corresponding interrupt time slice period. The apparatus also comprises means for interrupting a thread from running on a computer processor unit in order to determine whether to schedule one or more pending threads upon expiration of the scheduler timer circuit.

The apparatus may further comprise means for generating the signal indicating the change from the current frame rate quality of service requirement.

The means for determining a corresponding time slice period may include means for retrieving the corresponding time slice period associated with the new frame rate quality of service requirement from a table.

The means for determining a corresponding time slice period may include means for dividing the period of the new frame rate quality of service requirement by x where x is less than 3 and greater than or equal to 2.

The means for determining a corresponding time slice period may include means for receiving the corresponding time slice period from an AI engine.

### BRIEF DESCRIPTION OF THE DRAWINGS

FIG. 1 is an exemplary timing diagram of a computer processor unit's time slice being smaller than an FPS (frame per second) rate QoS (Quality of Service) requirement;

FIG. 2 is a block diagram of an exemplary consumer device that dynamically varies the scheduler timer circuit in response to a new frame rate QoS requirement;

FIG. 3 is a block diagram of exemplary threads that run on a computer processor deployed in a consumer electronic device;

FIG. 4 is a block diagram illustrating various embodiments for the frame rate source circuit in FIG. 2;

FIG. 5 is a block diagram illustrating various alternatives for determining a corresponding time slice period;

FIG. 6 is a flowchart illustrating an exemplary process for dynamically varying time slices in a CPU;

FIG. 7 is a timing diagram when time slices are varied in response to different FPS rate QoS requirements; and

FIG. 8 is a block diagram of an exemplary processor-based system that can include the system of FIG. 3.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

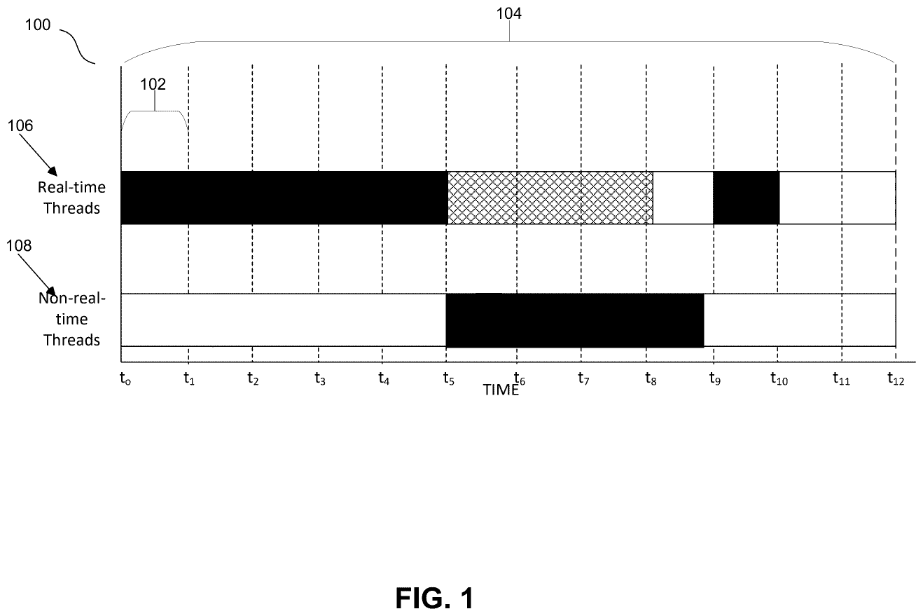

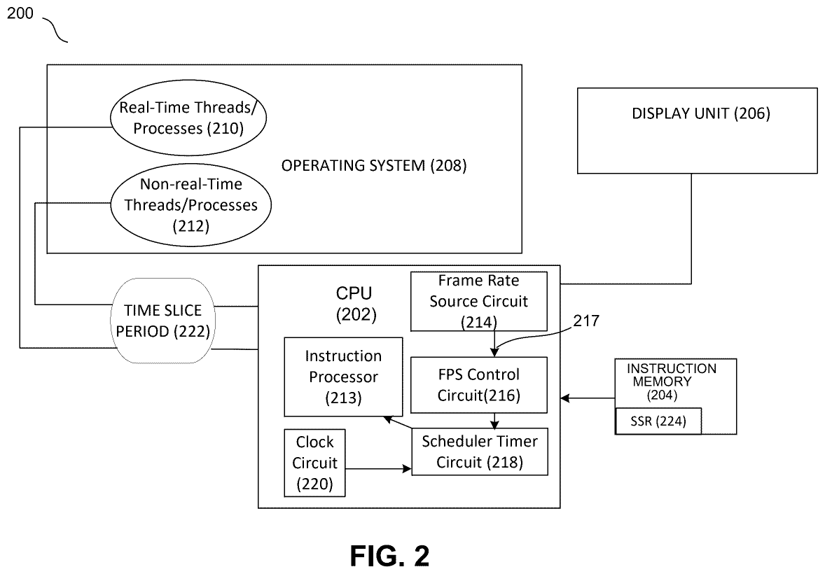

Before discussing examples of dynamically varying time slices of a central processing unit (CPU) in response to a change in the FPS (frames per second) QoS (Quality of Service) requirement starting at FIG. 2, an example of a computer processor unit that is set to fixed clock rate to generate a scheduler interrupt in response to the maximum FPS QOS requirement supported by a display is first described with regard to FIG. 1 below.

Today's computer processor units, including CPUs and graphic processing units (GPUs), render text and images for physical displays. As physical displays have evolved, they have been able to support variable FPS QoS requirements. Applications such as gaming, where scenes are varied and often updated, have high FPS QoS requirements. Because screens are less varied than video games and updates occur much less frequently, applications such as word processing have relatively low FPS QoS requirements. In order to render text and images for physical display, real-time rendering threads/processes, threads/processes that have high priority, must have their work completed within a fixed period of time in order to not drop video frames. In many consumer electronic devices, including PCs, laptops, and mobile phones, operating systems require a static system FPS rate setting at which a display will run.

However, since today's physical displays can support running at different FPS rates, users generally set a static system FPS QoS to the highest frame rate supported in order to support applications that require these high FPS rates when they are run. Correspondingly, the CPU time slice, also known as time slice period allocated to a running thread before a scheduler interrupt is generated, is set according to the highest FPS QoS requirement. A varying FPS QoS requirement may be supported in other operating systems without varying the CPU time slice. Consequently, in both of those types of existing operating systems, when consumer electronic devices are running applications that don't require the highest FPS QoS and correspondingly relatively short time slices, needless energy is being consumed by too frequent interrupts being generated, and the elapsed time to completion of a thread/processor takes longer than it has to.

For example, a user may transition from playing a game on their mobile device to reading the news. In many of today's operating systems, the FPS rate will be fixedly set to the highest FPS rate supported by the display to support gaming, and the CPU time slice will be correspondingly set to a shorter relative time period to service real-time, high-priority rendering threads/processes that need to be scheduled more often in order to complete their work. When the user transitions to reading the news, the news application, non-real-time application threads, will continue to be interrupted at the same rate that was needed by the previously running gaming application that the user is no longer playing. As a result, needless energy will be consumed due to the frequent interrupts generated by a short CPU time slice.

FIG. 1 is an exemplary timing diagram 100 of a CPU time slice 102 being smaller than frame period requirement 104, which is the inverse of an FPS rate QoS requirement. For simplicity, all of the real-time threads that are required to complete within the frame period requirement 104 are aggregated in one real-time threads timeline 106, and all the non-real-time threads that are independent of the FPS rate QoS requirement are aggregated in one non-real time threads timeline 108. The non-real-time threads are independent of FPS rate QoS requirements. However, the real-time and non-real-time threads, timeline 106 and timeline 108, respectively, depend on the CPU time slice 102. CPU time slice 102 is the period at which a CPU is interrupted by a scheduler at the expiration of a scheduler timer. This timing diagram 100 occurs when the FPS rate QoS requirement is reduced from a more stringent requirement, and the CPU time slice 102 was initialized to support a faster FPS rate QoS requirement. In timing diagram 100, real-time threads execute on the CPU between time to and time t₅. At time t₅, a scheduler is invoked and recognizes that real-time threads are waiting for a resource. As such, the scheduler schedules and dispatches the non-real-time threads that were pending threads just prior to time t₅. The non-real-time threads run and complete their work just prior to time to. In other words, non-real-time threads can be slotted to run on the CPU within the wait time of real-time threads waiting for resources. When the scheduler is invoked at time to, the scheduler will continue to allow non-real-time threads to execute on the CPU. Shortly after time to, the resource for which real-time threads were waiting is available so that the scheduler at time to will schedule and dispatch the real-time threads to execute on the CPU. Additionally, just prior to time to, the non-real-time threads completed their work. At time t₁₀, the real-time threads are complete in time to meet the FPS rate requirement. In this scenario, where the CPU time slice 102 is smaller than the inverse of the FPS rate requirement, there are many scheduler interrupts where there is no change in the running of threads (ex., t₁-t₄, t₆-t₇). Because of the poor relationship between CPU time slice 102 and the frame period requirement 104 as shown in FIG. 1, power consumption is wasted due to those too frequent scheduler interrupts.

Unlike the timing diagram 100 of FIG. 1, exemplary aspects include dynamically varying a thread execution time slice in a processor in response to detected changes in FPS QoS requirements. In exemplary aspects, the computer processor is included in a processor-based system that includes other peripheral devices, such as memory and input/output (I/O) devices, such as a display, as examples. The computer processor and/or operating system (OS) is configured to generate a scheduler interrupt in response to a timer signal that is generated by a timer circuit. The computer processor and/or its operating system is configured to execute a scheduler service routine in response to the scheduler interrupt to schedule pending threads for execution. Thus, the frequency of the timer signal controls the frequency or time slice allocated to the current thread being executed before the thread is interrupted for the scheduler service routine to determine whether to re-schedule pending threads. In computer processors employed in applications that control display functions, certain threads that are involved in display operations (e.g., rendering, composition, refresh) have an FPS QoS requirement so that those threads complete their work without dropping frames. In exemplary aspects, to avoid having a fixed timer signal be at a frequency to achieve the maximum FPS QoS requirement, which in turn causes a higher power consumption from more frequent scheduler interrupts, the processor or its operating system can dynamically change the frequency of the timer signal to control the duration of the thread time slice to still be sufficient to service the current FPS QoS. In this manner, the thread time slice is shortened or lengthened to a time frame that corresponds to service a current FPS QoS requirement.

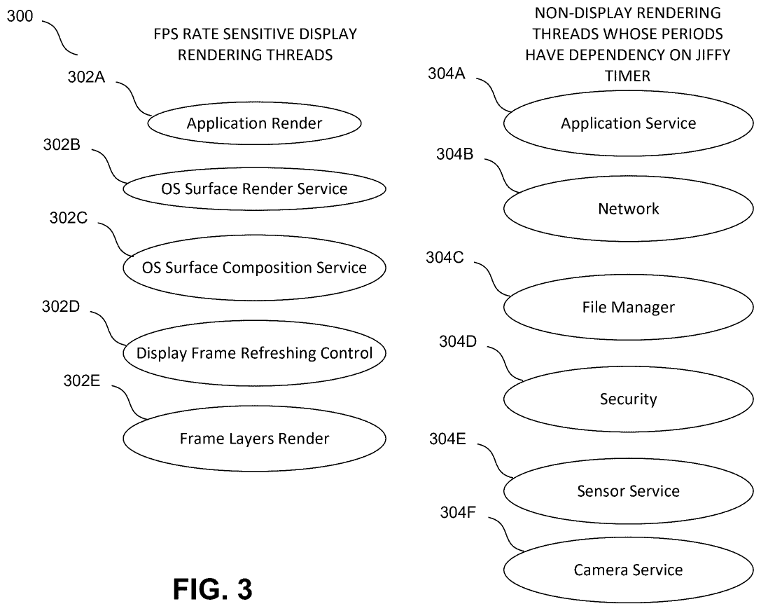

In this regard, FIG. 2 is a block diagram of an exemplary consumer device 200 that dynamically varies the scheduler timer in response to a new frame rate QoS requirement. Consumer device 200 at least includes computer processor unit 202 (CPU), instruction memory 204, and a display unit 206. An operating system 208 runs on CPU 202, including real-time threads/processes 210 and non-real-time thread/processes 212. Operating system 208 can include Android, IOS, Windows, or any other operating system that will run on consumer electronic devices. Real-time threads/processes 210 include the threads that are required to complete their work prior to an FPS rate QoS requirement in order to render text and graphics on the display unit 206. Both real-time threads/processes 210 and non-real-time threads/processes 212 execute on the CPU (202). Some examples of real-time and non-real-time threads will be discussed in connection with FIG. 3.

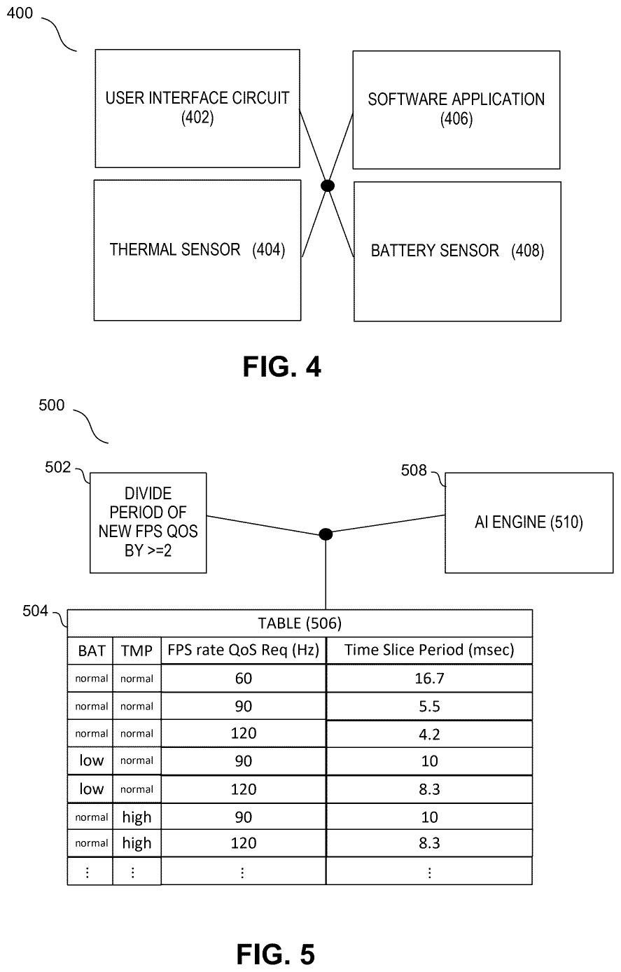

CPU 202 at least includes an instruction processor 213, a frame rate source circuit 214, a frames per second (FPS) control circuit 216, a scheduler timer circuit 218, and a clock circuit 220. The frame rate source circuit 214 signals the FPS control circuit 216 with a new FPS rate QoS requirement. Alternative implementations of the frame rate source circuit 214 will be discussed in connection with FIG. 4. Upon receipt of the signal 217 indicating new FPS rate QoS requirement, the FPS control circuit 216 will determine a corresponding time slice period 222 based on the new FPS rate QoS requirement and set the scheduler timer circuit 218 to the corresponding time slice period. Clock circuit 220 generates ticks to the scheduler timer circuit 218. Once the number of ticks equates to the corresponding time slice period, the scheduler timer circuit 218 interrupts instruction processor 213, which in turn loads the scheduler service routine (SSR) 224 from instruction memory 204. Instruction processor 213 runs SSR 224 to determine whether a currently running thread should be switched out to run a higher priority pending thread that has been waiting. When running the SSR 224, the real-time threads/processes 210 and the non-real-time threads/processes 212 will run according to the corresponding time slice period 222. The same SSR 224 may also run on other CPUs in a multi-processor system and thus control the time slice period for the threads and processes running on the other CPUs. By utilizing the corresponding time slice period 222, which is based on the FPS rate QoS requirement, needless scheduler interrupts, as shown in FIG. 1, will be reduced.

In consumer devices running the Android operating system, scheduler timer circuit 218 includes a jiffie timer which runs in the kernel of the Android operating system. Also, the FPS control circuit 216 is implemented in software as either a device driver or a service running in Android.

FIG. 3 is a block diagram 300 of an exemplary, non-exhaustive set of threads that run on a CPU deployed in a consumer electronic device. Real-time threads 302A-302E should be completed within the FPS rate QoS requirement. Non-real-time threads 304A-304F are not subject to the FPS rate QoS requirement. Real-time threads 302A-302E and non-real-time threads 304A-304F will run when dispatched at the current setting of a time slice period 222.

Application service 304A is one or more threads that run in the background and run an application, such as a game, word processor, or web browser. Network 304B is one or more threads responsible for managing network connectivity, including WiFi, Bluetooth, and cellular networks. File manager 304C is one or more threads responsible for managing access to storage on a consumer electronic device. Security 304D is one or more threads responsible for monitoring and preventing security breaches. Camera service 304F is one or more threads responsible for controlling a camera on a consumer electronic device.

Real-time threads 302A-302E that are dependent on FPS rate QoS requirements include application render 302A, OS surface render service 302B, OS surface composition service 302C, display frame refreshing control 302D, and frame layers render 302E. Application render 302A includes one or more threads associated with application service 304A and is responsible for providing access functionality of a display to application service 304A. OS surface render service 302B includes one or more threads associated with various applications being run on the CPU and whose responsibility is to provide display services to the various applications being run on the CPU. OS surface composition service 302C includes one or more threads that are responsible for aggregating multiple application renderings. Display frame refreshing control 302D and frame layers render 302E are traditionally device driver-level threads that control the hardware associated with a display. Display frame refreshing control 302D includes one or more threads to control display refreshing. Frame layers render 302E includes one or more threads to control the CPU to perform the actual render task at a physical display.

FIG. 4 is a block diagram 400 illustrating various embodiments for the frame rate source circuit 214 in FIG. 2. The frame rate source circuit 214 may include a user interface circuit 402 for receiving end-user requests for a new FPS rate QoS requirement. In this embodiment, the frame rate source circuit 214 receives end-user requests to signal the FPS control circuit 216 to determine a new time slice period corresponding to the new FPS rate QoS requirement. The frame rate source circuit 214 may also include a thermal sensor 404 that reports a new FPS rate QoS requirement in response to a temperature of CPU 202 crossing a temperature threshold. The frame rate source circuit 214 may also include a software application 406 which runs on CPU 202 and reports a new FPS rate QoS requirement. The frame rate source circuit 214 may also include a battery sensor 408 that reports a new FPS rate QoS requirement in response to the energy level of the battery crossing a battery level threshold. One or more of these embodiments, in any combination, may be deployed simultaneously in the same frame rate source circuit 214.

FIG. 5 is a block diagram 500 illustrating various alternatives for determining a corresponding time slice period 222. At alternative 502, FPS control circuit 216 calculates time slice period 222 by dividing the period of the new FPS rate QoS requirement by 2. Although this calculation is preferred, dividing the period of the new FPS rate QoS requirement by any real number between 2 and 3 will achieve a sufficient time slice period to correspond to the new FPS rate QoS requirement.

In alternative 504, FPS control circuit 216 refers to a pre-configured table of FPS rate QoS requirements 506 to retrieve a corresponding time slice period 222. When the battery level (“BAT”) and the temperature level (“TMP”) are in the normal operating range (“norm”), FPS control circuit 216 looks up the new FPS rate QoS requirement (“FPS rate QOS Req”) in pre-configured table 506 to retrieve the corresponding “Time Slice Period” and sets the scheduler timer circuit 218 to the retrieved “Time Slice Period.” If the battery level is reported low by a battery sensor or the temperature level is reported high by a temperature sensor, the FPS control circuit 216 matches the “BAT” and “TMP” fields along with matching the “FPS rate QoS Req” field in pre-configured table 506 to determine the corresponding “Time Slice Period.” For example, if the battery level is reported as “low,” the temperature level is reported as “normal,” and the new FPS rate QoS requirement is 120 Hz, the FPS control circuit 216 will set a time slice period 222 to 8.3 msec.

In alternative embodiment 508, FPS control circuit 216 includes an AI engine 510. AI engine 510 monitors the performance of CPU 202, battery levels, temperature levels, and needless interrupts from scheduler timer circuit 218 to determine appropriate matches between FPS rate QoS requirements and time slice period 222 for the various combinations of battery levels and temperature levels. In other words, FPS control circuit 216 dynamically creates a table, similar to the pre-configured table 506, that it uses to look up a corresponding time slice period in response to receiving a new FPS rate QoS requirement.

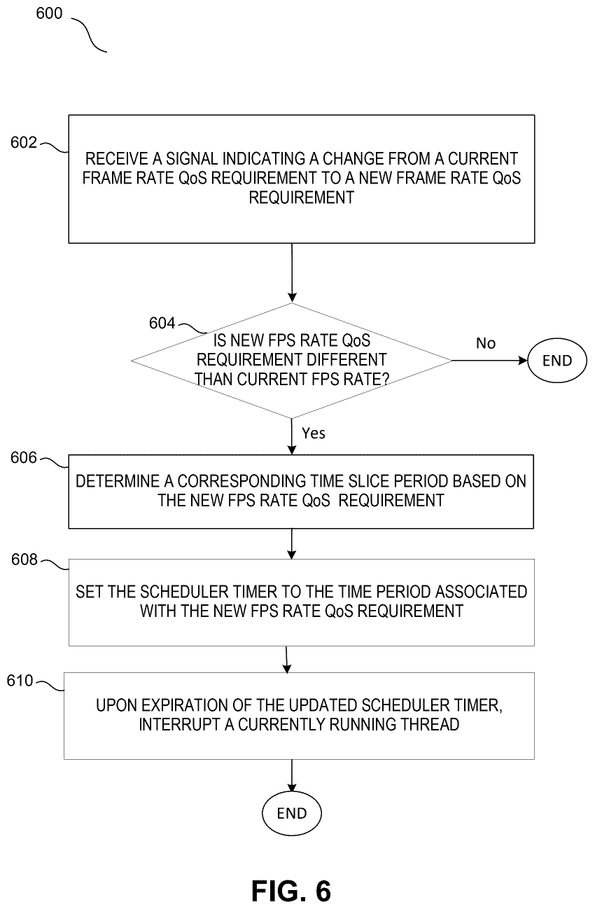

FIG. 6 is a flowchart illustrating an exemplary process 600 for dynamically varying time slice periods 222 in a CPU 202. At block 602, process 600 receives a signal indicating a change from a current frame rate QoS requirement to a new frame rate QoS requirement. At block 604, process 600 determines whether the new frame rate QoS requirement is different, or at least within some tolerance level as the current frame rate QoS requirement. At block 606, process 600 determines a corresponding time slice period based on the new FPS rate QoS requirement. At block 608, process 600 sets the scheduler timer to the time slice time period associated with the new FPS rate QoS requirement. At block 610, process 600 interrupts a thread currently running on CPU 202 upon the expiration of the updated scheduler timer.

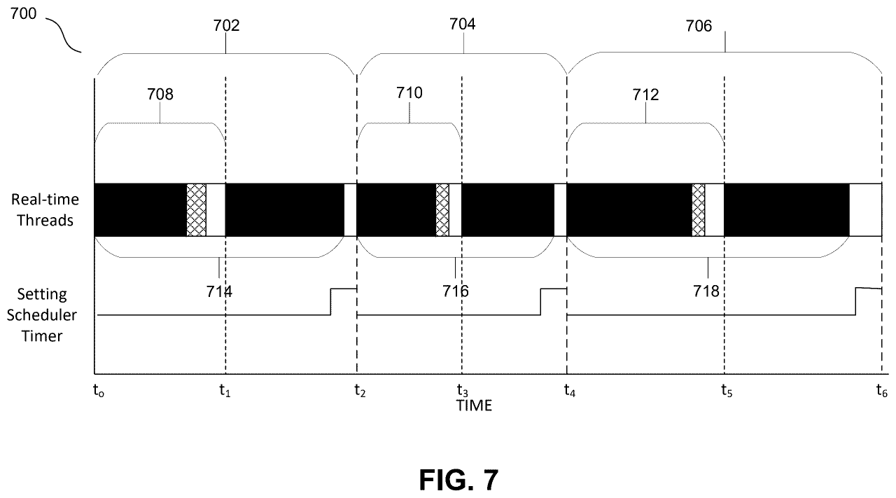

FIG. 7 is a timing diagram 700 when time slice periods are varied in response to different FPS rate QoS requirements. Timing diagram 700 illustrates a scenario where three different FPS rate QoS requirements were reported to the FPS control circuit 216. The periods of the three different FPS rate QoS requirements correspond to time periods 702, 704, and 706. In response to FPS rate QoS requirements, the three different FPS rate QoS requirements, FPS control circuit 216 sets the time slice period 222 to time slice periods 708, 710, and 712, respectively. As shown in FIG. 7, time slice periods 708, 710, and 712 are approximately half of the time periods 702, 704, and 706, respectively, for the three different FPS rate QoS requirements. Time periods 714, 716, and 718 show that the real-time threads complete within their respective time periods 702, 704, and 706, which correspond to three different FPS rate QoS requirements. Just prior to t₂, timing diagram 700 illustrates setting the scheduler timer circuit 218 to time slice period 710 in response to receiving the new FPS rate QoS requirement (which corresponds to time period 704). At t₂, real-time threads begin to be interrupted by CPU 202 every time slice period 710. Just prior to t₄, timing diagram 700 illustrates setting the scheduler timer circuit 218 to time slice period 712 in response to receiving the new FPS rate QoS requirement (which corresponds to time period 706). At t₄, real-time threads begin to be interrupted by CPU 202 every time slice period 712. As illustrated by FIG. 7, time slice periods are matched with the changing FPS rate QoS requirements to lessen needless task switching to save power consumption while ensuring the real-time threads complete their work within the FPS rate QoS requirement in order to avoid frame drops.

According to aspects disclosed herein, dynamically varying time slice periods in a CPU may be provided in or integrated into any processor-based consumer device. Examples, without limitation, include a set-top box, an entertainment unit, a navigation device, a communications device, a fixed location data unit, a mobile location data unit, a global positioning system (GPS) device, a mobile phone, a cellular phone, a smartphone, a session initiation protocol (SIP) phone, a tablet, a phablet, a computer, a portable computer, a mobile computing device, a wearable computing device (e.g., a smartwatch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

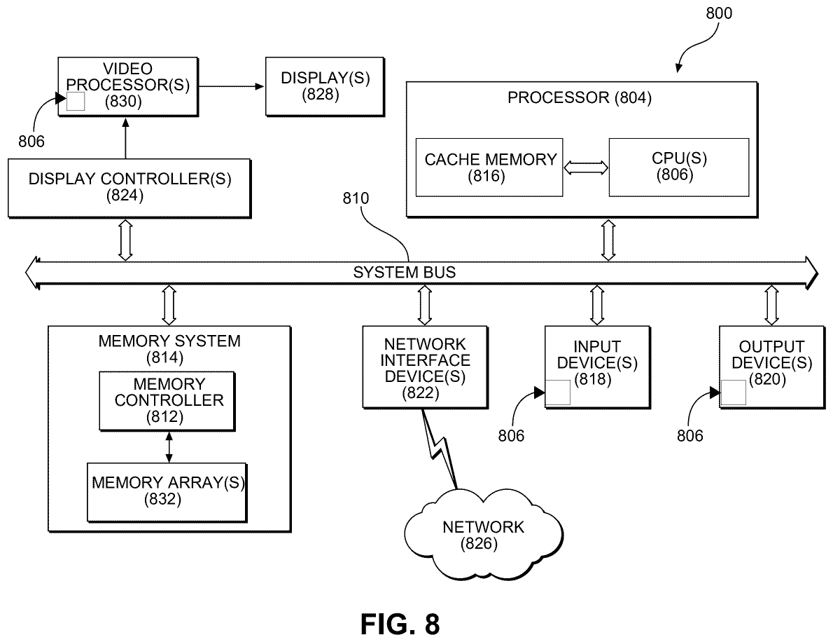

In this regard, FIG. 8 illustrates an example of a processor-based system 800 that can employ dynamically varying time slice periods in a CPU 202, as illustrated in FIG. 2. In this example, the processor-based system 800 includes processor 804, each including one or more CPUs 806. The CPU(s) 806 may have cache memory 816 coupled to the processor 804 for rapid access to temporarily stored data. CPU(s) 806 is a CPU similar to CPU 202 illustrated in and discussed in connection with FIG. 2. The CPU(s) 806 is coupled to a system bus 810 and can intercouple devices included in the processor-based system 800. As is well known, the CPU(s) 806 communicates with these other devices by exchanging address, control, and data information over the system bus 810. For example, the CPU(s) 806 can communicate bus transaction requests to a memory controller 812. Although not illustrated in FIG. 8, multiple system buses 810 could be provided, wherein each system bus 810 constitutes a different fabric.

Other devices can be connected to the system bus 810. As illustrated in FIG. 8, these devices can include a memory system 814, one or more input devices 818, one or more output devices 820, one or more network interface devices 822, and one or more display controllers 824, as examples. The input device(s) 818 can include any type of input device, including, but not limited to, input keys, switches, voice processors, etc. The output device(s) 820 can include any type of output device, including, but not limited to, audio, video, other visual indicators, etc. The network interface device(s) 822 can be any device configured to allow an exchange of data to and from a network 826. The network 826 can be any type of network, including, but not limited to, a wired or wireless network, a private or public network, a local area network (LAN), a wireless local area network (WLAN), a wide area network (WAN), a BLUETOOTH™M network, and the Internet. The network interface device(s) 822 can be configured to support any type of communications protocol desired. The memory system 814 can include one or more memory arrays 832.

The CPU(s) 806 may also be configured to access the display controller(s) 824 over the system bus 810 to control information sent to one or more displays 828. The display controller(s) 824 sends information to the display(s) 828 to be displayed via one or more video processors 830, which process the information to be displayed into a format suitable for the display(s) 828. The display(s) 828 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory, or another computer-readable medium wherein any such instructions are executed by a processor or other processing device, or combinations of both. As examples, the CPUs described herein may be employed in any circuit, hardware component, integrated circuit (IC), or IC chip. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

According to aspects disclosed herein, dynamically varying time slice periods in a CPU may be implemented or performed in a graphics processing unit (GPU) Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A CPU may be a microprocessor, but in the alternative, the CPU may be a controller, microcontroller, or state machine. A CPU may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. An apparatus comprising:
a computer processor unit; and
a display unit;
the computer processor unit comprising:
a scheduler timer circuit; and
a frames per second control circuit configured to receive a signal indicating a new frame rate quality of service requirement, wherein in response to the signal indicating the new frame rate quality of service requirement, the frames per second control circuit is configured to determine a corresponding time slice period, and set the scheduler timer circuit to the corresponding time slice period, and wherein the computer processor unit is configured, upon expiration of the scheduler timer circuit, to interrupt a thread from running on the computer processor unit in order to determine whether to schedule one or more pending threads.

2. The apparatus of claim 1, further comprising:
a frame rate source circuit configured to generate the signal indicating the new frame rate quality of service requirement.

3. The apparatus of claim 2, wherein the frame rate source circuit is a thermal sensor configured to generate the signal indicating the new frame rate quality of service requirement when the thermal sensor senses a temperature beyond a temperature threshold.

4. The apparatus of claim 2, wherein the frame rate source circuit is a user interface circuit configured to generate the signal indicating the new frame rate quality of service requirement in response to input from a user.

5. The apparatus of claim 2, wherein the frame rate source circuit is an application configured to generate the signal indicating the new frame rate quality of service requirement based on requirements of the application.

6. The apparatus of claim 1, further comprising:
a pre-configured table of frames per second, FPS, rate QoS requirements and corresponding time slice periods, wherein the frames per second control circuit determines the corresponding time slice period by retrieving the corresponding time slice period associated with the new frame rate quality of service requirement from the pre-configured table of FPS rate QoS requirements.

7. The apparatus of claim 1, wherein the frames per second control circuit determines the corresponding time slice period by dividing a period of the new frame rate quality of service requirement by x where x is less than 3 and greater than or equal to 2.

8. The apparatus of claim 1, wherein the frames per second control circuit determines the corresponding time slice period by an artificial intelligence, AI, engine.

9. A method for dynamically varying time slice periods in a computer processor unit comprising:
receiving a signal indicating a change from a current frame rate quality of service requirement;
determining a corresponding time slice period in response to the signal indicating a new frame rate quality of service requirement;
setting a scheduler timer circuit of the computer processor unit to the corresponding time slice period; and
interrupting a thread from running on the computer processor unit in order to determine whether to schedule one or more pending threads upon expiration of the scheduler timer circuit.

10. The method of claim 9, further comprising:
generating the signal indicating the change from the current frame rate quality of service requirement.

11. The method of claim 9, wherein determining the corresponding time slice period includes retrieving the corresponding time slice period associated with the new frame rate quality of service requirement from a table.

12. The method of claim 9, wherein determining the corresponding time slice period includes dividing a period of the new frame rate quality of service requirement by x where x is less than 3 and greater than or equal to 2.

13. The method of claim 9, wherein determining the corresponding time slice period includes receiving the corresponding time slice period from an artificial intelligence, AI, engine.

14. The method of claim 9, wherein receiving the signal indicating a change from a current frame rate quality of service requirement, further comprising:
determining whether a new frame rate quality of service requirement is different than the current frame rate quality of service requirement;

15. A non-transitory computer-readable storage medium comprising instructions executable by a processor, which, when executed by the processor, causes the processor to periodically interrupt a running thread, the non-transitory computer-readable storage medium, comprising:
code for receiving a signal indicating a change from a current frame rate quality of service requirement;
code for determining a corresponding time slice period in response to the signal indicating a new frame rate quality of service requirement;
code for setting a scheduler timer circuit to the corresponding time slice period; and
code for interrupting a thread from running on a computer processor unit in order to determine whether to schedule one or more pending threads upon expiration of the scheduler timer circuit.

16. The non-transitory computer-readable storage medium of claim 15, further comprising:
code for generating the signal indicating the change from the current frame rate quality of service requirement.

17. The non-transitory computer-readable storage medium of claim 15, wherein code for determining the corresponding time slice period further includes:
code for retrieving the corresponding time slice period associated with the new frame rate quality of service requirement from a table.

18. The non-transitory computer-readable storage medium of claim 15, wherein code for determining the corresponding time slice period further includes:
code for dividing a period of the new frame rate quality of service requirement by x where x is less than 3 and greater than or equal to 2.

19. The non-transitory computer-readable storage medium of claim 15, wherein code for determining the corresponding time slice period further includes:
code for receiving the corresponding time slice period from an artificial intelligence, AI engine.

20. An apparatus comprising:
means for receiving a signal indicating a change from a current frame rate quality of service requirement;
means for determining a time slice period in response to the signal indicating a new frame rate quality of service requirement;
means for setting a scheduler timer circuit to the time slice period; and
means for interrupting a thread from running on a computer processor unit in order to determine whether to schedule one or more pending threads upon expiration of the scheduler timer circuit.

21. The apparatus of claim 20, further comprising:
means for generating the signal indicating the change from the current frame rate quality of service requirement.

22. The apparatus of claim 20, wherein the means for determining the time slice period includes:
means for retrieving the time slice period associated with the new frame rate quality of service requirement from a table.

23. The apparatus of claim 20, wherein the means for determining the time slice period includes:
means for dividing the time slice period of the new frame rate quality of service requirement by x where x is less than 3 and greater than or equal to 2.

24. The apparatus of claim 20, wherein the means for determining a corresponding time slice period includes:
means for receiving the corresponding time slice period from an artificial intelligence, AI, engine.
